(19) United States
(12) Patent Application Publication
(10) Pub. No.: US 2004/0199749 A1
(43) Pub. Date: Oct. 7, 2004

(54) Method and apparatus to limit register file read ports in an out-of-order, multi-stranded processor

(76) Inventors: Robert Golla, Round Rock, TX (US); Chandra M. R. Thimmannagari, Fremont, CA (US); Sorin Iacobovici, San Jose, CA (US); Rabin A. Sugumar, Sunnyvale, CA (US); Robert Nuckolls, Santa Clara, CA (US)

Correspondence Address: ROSENTHAL & OSHA L.L.P., Suite 2800, 1221 McKinney Street, Houston, TX, 77010, US

(21) Appl. No.: 10/406,551

(22) Filed: Apr. 3, 2003

(51) Int. Cl. G06F 9/30

(52) U.S. Cl. 712/218

(57) ABSTRACT

A method for limiting a number of register file read ports used to process a store instruction includes decoding the store instruction, where the decoding generates a decoded store instruction, identifying a store data register and source operand registers included in the decoded store instruction, and appending a set of attribute fields to the decoded store instruction. Further, dependent on a value of at least one of the attribute fields, source values corresponding to the source operand registers are read using the register file read ports at a time that the store instruction is issued, and a store data value corresponding to the store data register is read using one of the register file read ports at a time that the store instruction is committed.

### BACKGROUND OF INVENTION

A typical computer system includes at least a microprocessor and some form of memory. The microprocessor has, among other components, arithmetic, logic, and control circuitry that interpret and execute instructions necessary for the operation and use of the computer system. FIG. 1 shows a block diagram of a typical computer system (10) having: a microprocessor (12), memory (14), integrated circuits (16) that have various functionalities, communication paths (18), i.e., buses and wires, that transfer data among the aforementioned components of the computer system (10), and a clock (20) that is used to synchronize operations of the computer system (10).

Generally, the instructions interpreted and executed by the microprocessor (12) are generated by various processes, i.e., distinct instances of programs running on the computer system. In general, each process is associated with a particular set of data and/or events that influence the frequency and types of instructions that the process generates to the microprocessor (12). Often, the microprocessor (12) is required to handle multiple processes at the same time.

The microprocessor (12) may be arranged to handle processes sequentially or simultaneously. In a case where the microprocessor is arranged to handle processes sequentially, all or part of the instructions in a first process are interpreted/executed before the operating system forces the microprocessor (12) to suspend the first process and execute a subsequent process. In sequential processing, the microprocessor (12) includes a single set of all computing resources, e.g., register files, instruction queues, caches, buffers, counters, etc. Consequently, the microprocessor (12) may encounter a case in which the first process incurs a long latency, i.e., a long delay in which few or no instructions are executed, and, hence, a latency period in which no useful work is done by the microprocessor (12). As a result, processing time may be wasted and the efficiency of the microprocessor (12) may be decreased.

One method in which designers decrease the amount of microprocessor latency incurred is by arranging the microprocessor (12) to handle processes simultaneously, i.e., to alternate between processes, or, in other words, to provide support for multiple strands. In particular, when a long latency occurs in a first process, the microprocessor (12) may be able to switch to a second process in order to interpret/execute instructions generated by the second process. Thus, the latency period that may have been incurred during sequential processing may now be used in simultaneous processing to perform useful work.

Typically, the microprocessor includes multiple computing resources, e.g., register files, instruction queues, caches, buffers, counters, etc., that may be used to handle multiple processes' strands, i.e., architectural implementations. When the microprocessor (12) is arranged to handle a single strand, that strand may be allowed sole use of the microprocessor's resources in order to interpret/execute the strand's instructions. Alternatively, when the microprocessor (12) is arranged to handle multiple strands, the strands may be required to share many of the microprocessor's resources. In a case where strands share resources, the microprocessor (12) has to ensure that microprocessor computation time is used effectively while also ensuring that each strand is allowed fair use of the resources.

### SUMMARY OF INVENTION

According to one aspect of the present invention, a method for limiting a number of register file read ports used to process a store instruction comprises decoding the store instruction, wherein the decoding generates a decoded store instruction; identifying a store data register and source operand registers included in the decoded store instruction; appending a set of attribute fields to the decoded store instruction; and dependent on a value of at least one attribute field of the set of attribute fields, reading source values corresponding to the source operand registers using at least one of the register file read ports at a time that the store instruction is issued, and reading a store data value corresponding to the store data register using one of the register file read ports at a time that the store instruction is committed.

According to another aspect of the present invention, an apparatus for limiting a number of register file read ports used to process a store instruction comprises an instruction decode unit arranged to decode a store instruction into a decoded store instruction and to append a set of attribute fields to the decoded store instruction; a rename and issue unit arranged to read source operands for the decoded store instruction dependent on values of the set of attribute fields; an instruction execution unit arranged to execute the decoded store instruction using the source operands, wherein execution of the decoded store instruction generates an address value; a data cache unit arranged to receive the address value, wherein the data cache unit generates a physical address value dependent on the address value; and a commit unit arranged to commit the decoded store instruction dependent on the physical address value, wherein, upon commitment of the decoded store instruction, a store data value is stored to a store queue of the data cache unit.

According to another aspect of the present invention, an apparatus for processing a store instruction comprises means for decoding the store instruction into a set of source operand registers and a store data register; means for appending a set of attribute fields to the store instruction dependent on the set of source operand registers and the store data register; means for reading source operands from a register file dependent on values of the set of attribute fields; means for generating an address value for the store instruction dependent on the source operands and the store instruction; means for committing the store instruction dependent on the means for generating and the set of attribute fields; and means for receiving a store data value from the store data register dependent on the means for committing.

Other aspects and advantages of the invention will be apparent from the following description and the appended claims.

### BRIEF DESCRIPTION OF DRAWINGS

FIG. 1 shows a block diagram of a typical computer system.

FIG. 2 shows a block diagram of a pipeline of an out-of-order, multi-stranded processor in accordance with an embodiment of the present invention.

FIG. 3 shows a block diagram of exemplary instruction formats for a store instruction in accordance with an embodiment of the present invention.

FIG. 4 shows a block diagram of data movement for a store instruction in accordance with an embodiment of the present invention FIG. 5 shows a block diagram of exemplary portions of a multi-stranded processor that are used to support data movement for store instructions in accordance with an embodiment of the present invention.

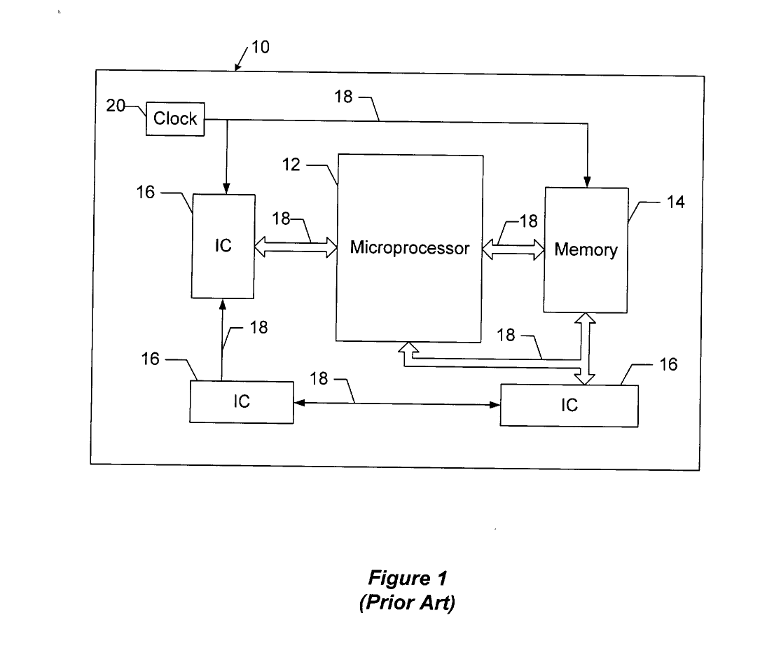

### DETAILED DESCRIPTION

The present invention involves a method for limiting a number of read ports for a register file in an out-of-order processor. An out-of-order processor, for the purposes of the present invention, is defined as a processor that is capable of committing instructions executed for a particular strand in an order other than the order in which the instructions were issued for the strand. A register file read port, for the purposes of the present invention, is defined as a data output port in a register file that may be used to read data values stored at register addresses of the register file. The number of read ports for a register file in an out-of-order processor is limited by limiting the number of register file read ports that are required to process store instructions. The out-of-order processor limits the number of register file read ports that are required to process a store instruction by allowing data movement for the store instruction to occur at the time that the store instruction is committed.

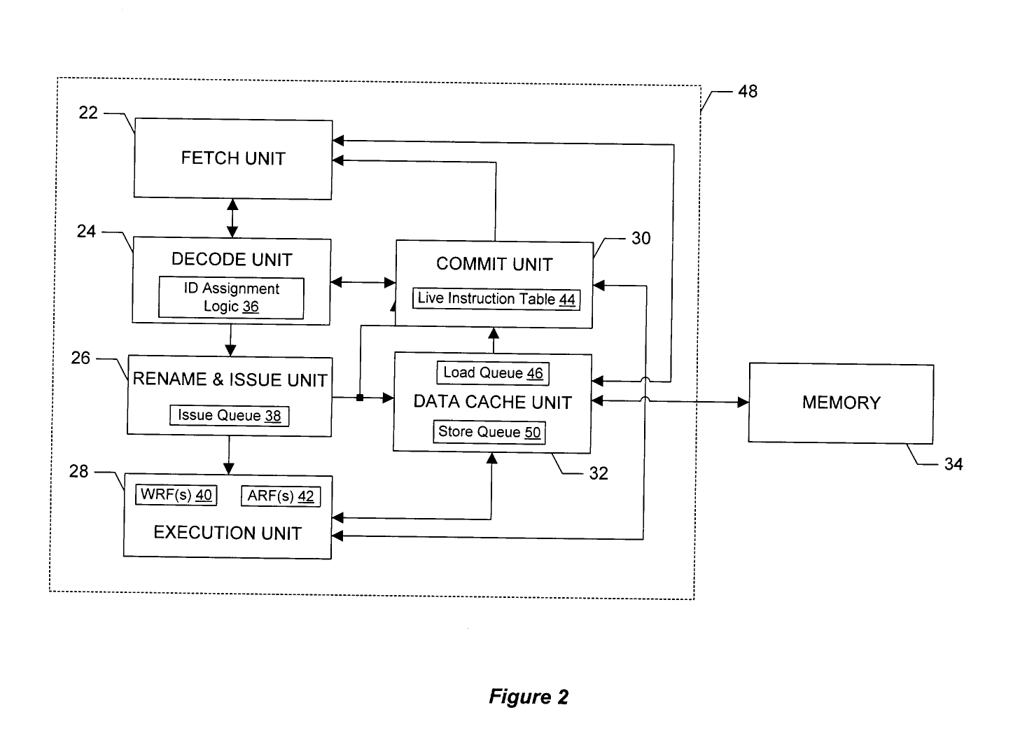

Illustrative embodiments of the invention will now be described with reference to FIGS. 2-5 wherein like reference characters are used to denote like parts throughout the views.

FIG. 2 shows a block diagram of an exemplary pipeline of an out-of-order, multi-stranded processor in accordance with an embodiment of the present invention. For the purposes of the present invention, a multi-stranded processor is defined as a processor that may be arranged to handle one or more strands. In the embodiment shown in FIG. 2, the pipeline includes a microprocessor (48) and a memory (34). Further, the microprocessor (48) includes the following functional units: an instruction fetch unit (22), an instruction decode unit (24) having an ID assignment logic (36), a rename and issue unit (26) having an issue queue (38), an instruction execution unit (28) having a set of working register files (40) including one or more types of working register files and a set of architectural register files (42) including one or more types of architectural register files, a commit unit (30) having a live instruction table (44), and a data cache unit (32) having a load queue (46) and a store queue (50).

In the embodiment shown in FIG. 2, the types of working register files included in the set of working register files (40) may include, but are not limited to, a condition code working register file, an integer working register file, and a floating point working register file. Further, the types of architectural register files included in the set of architectural register files (42) may include but are not limited to a condition code architectural register file, an integer architectural register file, and a floating point architectural register file.

Note that any of the above functional units may further be described by internal pipeline(s), be subdivided into a number of subunits, and/or use more than one processing stage, e.g., clock cycle, to complete tasks handled by each functional unit. Further, those skilled in the art will appreciate that the pipeline may include more or less functional units than shown without departing from the scope of the present invention.

Referring to FIG. 2, the instruction fetch unit (22) is designed to fetch instructions from the strands being processed using a set of instruction buffers (not shown). The instruction fetch unit (22) includes at least as many instruction buffers as a maximum number of strands that the microprocessor (48) is designed to process. For example, in some embodiments, the microprocessor (48) may be designed to process a maximum of two strands. Thus, the instruction fetch unit (22) includes at least two instruction buffers (one for each strand) that may each fetch a bundle of instructions, i.e., a fetch group, from a desired strand. The maximum number of instructions that may be included in a fetch group is predetermined by a design and/or an architecture of the microprocessor (48). In some embodiments, a fetch group may include three instructions.

In the instruction decode unit (24), the fetch groups pulled from the instruction buffers are decoded sequentially. Thus, the instructions in a first fetch group are decoded before proceeding to the instructions in a second fetch group. In the embodiment shown in FIG. 2, each fetch group is decoded using two internal processing stages that are each responsible for partial decoding of an instruction. In general, the tasks that are completed during the first internal processing stage, referred to herein as D1, include: breaking complex instructions into simple instructions, killing delay slot instructions for certain branch conditions, identifying valid instructions and managing queue resources, looking for front end stall conditions, and determining strand switch conditions. The tasks that are completed during the second internal processing stage, referred to herein as D2, include: identifying type variables (i.e., integer type, operation type, etc.) associated with valid instructions, assigning IDs to the valid instructions, and handling strand switches and stalls resulting from resource scarcity.

The ID assignment logic (36) is responsible for assigning a working register file ID (WRF_ID), which identifies a location in one of the working register files, to each decoded, valid instruction that gets forwarded by the instruction decode unit (24). The WRF_ID identifies which location in the desired working register file (40) gets updated upon the execution of an instruction. In addition, the instruction decode unit (24) is also responsible for forwarding other fields, e.g., instruction type information, store type information, etc., that may be used to process the decoded instruction.

Decoded, valid instructions are passed to the both the commit unit (30) and the rename and issue unit (26). In the commit unit (30), the instructions are used to update the live instruction table (44), i.e., an instruction table that stores a copy of each active, valid instruction in the pipeline. The number of valid instructions that may be stored by the live instruction table (44) is predetermined by the design of the microprocessor (48). In the embodiment shown in FIG. 2, the live instruction table (44), the issue queue (38), the load queue (46), and the working register file(s) included in the set of working register files (40) each store an equal number of instructions. In some embodiments, the above mentioned queue resources may store a maximum of 32 instructions. During a multi-strand mode, i.e., a mode in which the multi-stranded processor is arranged to process multiple strands, the queue resources are shared between the strands.

In the rename and issue unit (26), the instructions are renamed, picked, and issued to the instruction execution unit (28). The tasks completed during the rename stage include renaming source registers and updating rename tables. The tasks completed during the pick stage include: monitoring a ready status of instructions in the issue queue (38), prioritizing the instructions that have a ready status, and selecting a number of instructions for issue. The number of instructions selected for issue is predetermined by the design of the microprocessor (48), and in the embodiment shown in FIG. 2, may be equal to the number of instructions that are included in a fetch group. During the issue stage, instructions selected for issue are forwarded from the issue queue (38) to the instruction execution unit (28).

Note that some types of operations may require that data be loaded from the memory (34) in order to execute the instruction. For instructions that include these types of operations, a load request is generated to the data cache unit (32), which is responsible for loading data to/from a cache portion of the data cache unit (32) using the load queue (46). In the case of a cache miss, the data cache unit (32) loads the requested data from the memory (34) using the load queue (46). The data may then be loaded from the load queue (46) into the instruction execution unit (28) for use in the instruction's execution.

The instruction execution unit (28) includes various computation units, e.g., an arithmetic logic unit, a shifter, a multiplier/divider, a branch execution unit, etc., that are used to execute the instructions. Each instruction is executed by the computational unit designed to handle that instruction's particular operation type. For example, an instruction identified as a multiplication operation is handled by the multiplier/divider. Once an instruction has been executed, the results of the computation are written into a register of the desired working register file(s) (40) and a status (or completion) report, is generated to the commit unit (30).

In the commit unit (30), instructions that have completed without exceptions are retired from active status and computational results are committed to architectural memory based on data received from the instruction decode unit (24) and completion reports. In the embodiment shown in FIG. 2, retirement and commitment is performed using three processing stages: an entry stage, a retire stage, and a commit stage. During the entry stage, the commit unit (30) tags completed instructions for retirement by writing the completion report data to the live instruction table (44).

Then, during the retire stage, the commit unit (30) selects a group of tagged instructions which have completed without exceptions to retire and signals the appropriate functional units, e.g., the instruction decode unit (24), the rename and issue unit (26), and/or the instruction execution unit (28), that the instructions are to be committed. In the embodiment shown in FIG. 2, instructions are retired according to age, i.e., older instructions retire first. Next, during the commit stage, the architectural state of each tagged instruction is committed by writing the associated computation results from the desired working register file(s) (40) to a register of the desired architectural register file(s) (42).

As mentioned above, the data cache unit (32) loads/stores data to/from the cache/memory (34) based on load/store requests received from the instruction execution unit (28). Load requests are handled using the load queue (46), while store requests are handled using both the load queue (46) and the store queue (50). In the case of a store request, the data cache unit (32) loads the memory address, i.e., the physical location in the memory (34), and hit/miss information for the store instruction sitting in the load queue (46) into the store queue (50) from the desired architectural register file(s) (42). Once the store instruction is ready to be committed, the data to be stored to the cache/memory (34) is loaded into the store queue (50) from the desired architectural register file(s) (42) depending on the store type (i.e., the type of store instruction). The data may then be forwarded from the store queue (50) to the cache/memory (34) when the store instruction is completed.

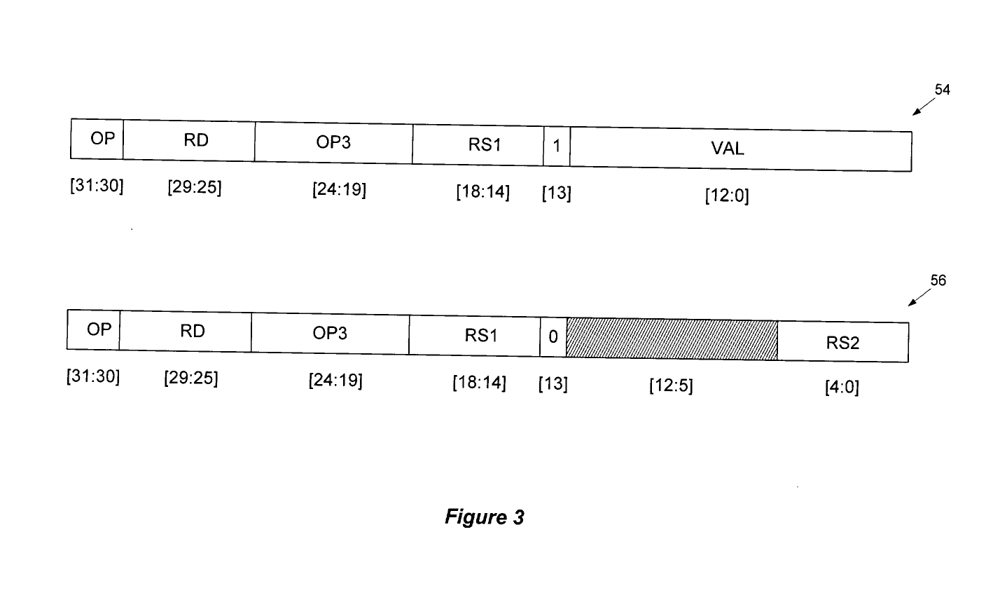

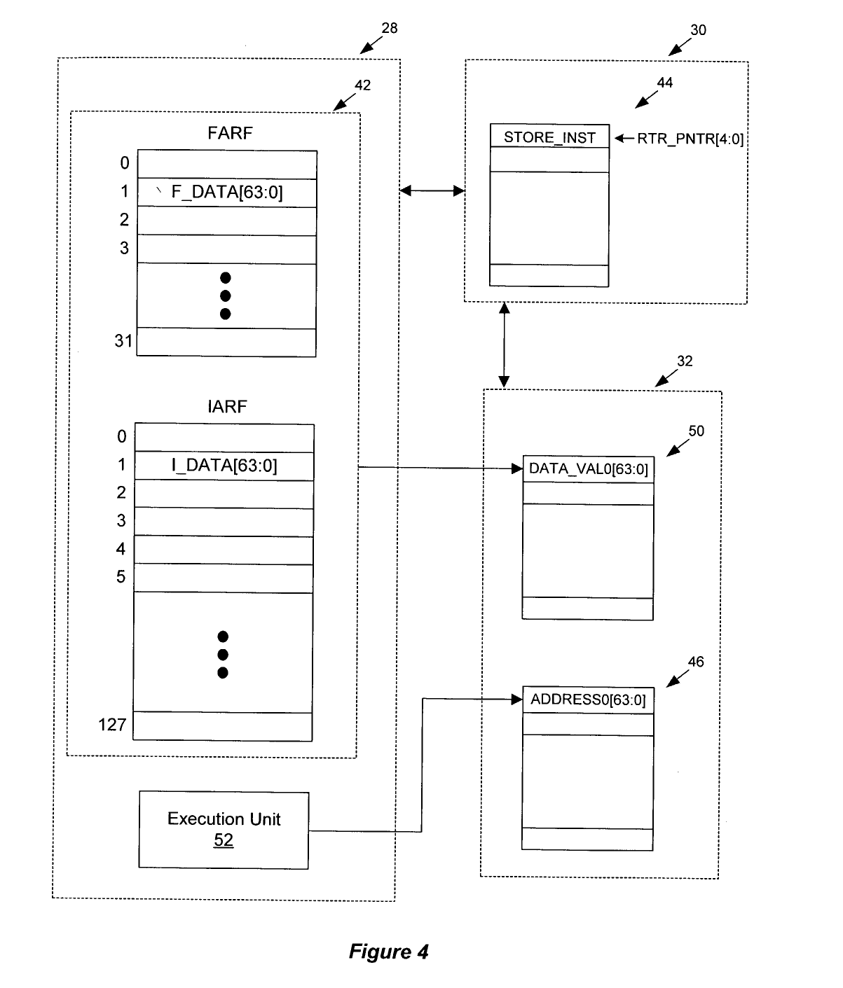

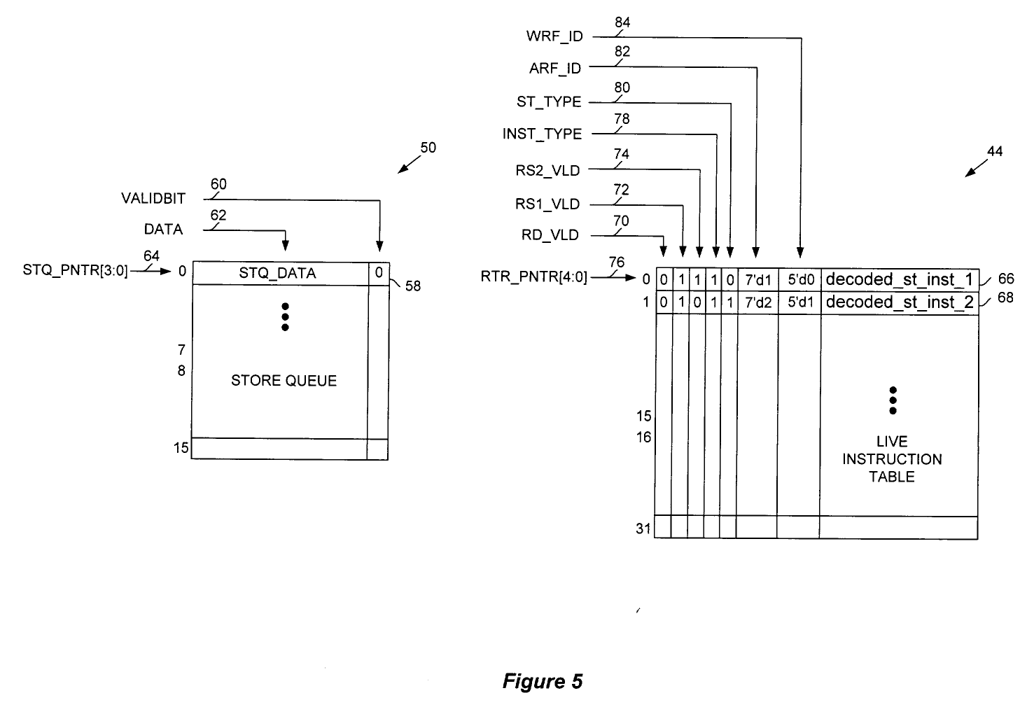

FIG. 3 shows a block diagram of exemplary instruction formats for a store instruction in accordance with an embodiment of the present invention. In accordance with one or more embodiments, the instruction format of a store instruction is determined at the time that the store instruction is decoded by the instruction decode unit (24 in FIG. 2). In the embodiment shown in FIG. 4, two instruction formats are shown. The first instruction format (54) includes the following: two operators (labeled OP and OP3), a source operand register (labeled RS1), a source operand value (labeled VAL), a store data register (labeled RD), and a bit value (shown as 1) that indicates the presence of an immediate data value, i.e., the source operand value. At the time that a store instruction having the first instruction format (54) is executed, VAL and the contents of RS1 are summed to generate an address value, which is used to identify a memory address to which the contents of RD will be stored.

The second instruction format (56) includes the following: two operators (labeled OP and OP3), two source operand registers (labeled RS1 and RS2), a store data register (labeled RD), and a bit value (shown as 0) that indicates the absence of an immediate data value, i.e., a source operand value. At the time that a store instruction having the second instruction format (56) is executed, the contents of RS1 and the contents of RS2 are summed to generate an address value which is used to identify a memory address to which the contents of RD will be stored. Note that, in the second instruction format (56), bits [12:5] are not used. In alternative embodiments, a third instruction format (not shown) may also be used in which bits [12:5] of the second instruction format (56) represent an immediate address space identifier.

In accordance with the embodiment shown in FIG. 3, store instructions may include two or more registers (a store data register and one or more source operand registers). Between the times that the store instruction is issued and the data corresponding to the store instruction is written to memory (34 in FIG. 2), the contents of the aforementioned registers need to be read from an appropriate register file, e.g., a working register file of the set of working register file(s) (40 in FIG. 2) and/or an architectural register file of the set of architectural register file(s) (42 in FIG. 2), in order to ensure that the correct value is written to a correct location in the data cache unit (32 in FIG. 2) and/or memory (34 in FIG. 2). Given the instruction formats presented in FIG. 3, a single store instruction may require that the register file have enough free read ports to read the contents of two or more registers at the time that the store instruction is issued in order to execute the store instruction.

In order to limit the number of read ports required to execute store instructions, one or more embodiments of the present invention ensure that the contents of RD are not read at the same time as the contents of RS1 and/or RS2. In accordance with one or more embodiments, the contents of RS1 and RS2 are read at the time that the store instruction is issued, and the contents of RD are read at the time that the store instruction is committed. Accordingly, movement of the data for the store instruction into the store queue (50 in FIG. 2) occurs at the time that the store instruction is committed.

FIG. 4 shows a block diagram of exemplary data movement for a store instruction at the time that the store instruction is committed in accordance with an embodiment of the present invention. In FIG. 4, once the instruction execution unit (28) receives a decoded store instruction, an execution unit (52) within the instruction execution unit (28) computes an address for the store instruction. The address, shown as ADDRESS0[63:0], is then forwarded to the data cache unit (32), which stores the address to an entry in the load queue (46) and uses the address to perform an address translation for the store instruction.

In order to perform the address translation, the data cache unit (32) inputs the address (ADDRESS0[63:0]) to an internal translation lookaside buffer (TLB) (not shown) as a virtual address. The TLB uses the virtual address to determine a physical address in the cache/memory (34) to which the data value may be stored once the store instruction is completed. Once the address translation is performed, the data cache unit (32) sends a completion report to the live instruction table (44) and informs the live instruction table (44) of whether the store instruction finished executing without exceptions (i.e., whether the address translation for the store instruction resulted in any exceptions).

If the store instruction finished executing without exceptions, then, when a retire pointer, shown as RTR_PTR[4:0], of the live instruction table (44) points to the appropriate table entry, the store instruction is committed by writing a data value, shown as DATA_VAL0[63:0] into the appropriate store queue (50) entry. The commit unit (30) selects the data value (DATA_VAL0[63:0]) from the appropriate architectural register file of the set of architectural register files (42) using store type information (i.e., whether the store instruction is an integer store, a floating point store, etc.) forwarded by the instruction decode unit (24 in FIG. 2). In the embodiment shown in FIG. 4, the commit unit (30) selects either a floating point data value, shown as F_DATA[63:0], from a floating point architectural register file (labeled FARF) or a integer data value, shown as I_DATA[63:0], from an integer architectural register file (labeled IARF).

FIG. 5 shows a block diagram of exemplary portions of the multi-stranded processor that are used to support data movement for store instructions in accordance with an embodiment of the present invention. In FIG. 5, a portion of the data cache unit (32 in FIG. 2) includes a store queue (50) having 16 entries, and a portion of the commit unit (30 in FIG. 2) includes a live instruction table (44) having 32 entries. When the multi-stranded processor is in a single strand mode, i.e., in a mode where only one strand is being processed, all of the entries in the live instruction table (44) and the store queue (50) are available to the active strand. When the multi-stranded processor is in a dual strand mode, i.e., in a mode where two strands are being processed, the live instruction table (44) makes 16 entries available to each strand. Further, the multi-stranded processor includes a dedicated 16 entry store queue structure for each strand being processed by the multi-stranded processor.

Each entry in the store queue (50) may include data corresponding to a single store instruction. In the embodiment shown in FIG. 5, entry 0 (58) includes a DATA field (62) and an attribute field shown as VALIDBIT (60). The DATA field (62) stores a data value, shown as STQ_DATA, corresponding to a first store instruction. The VALIDBIT field (60) is used by the data cache unit (32 in FIG. 2) to determine whether the store instruction needs to be completed, i.e., whether the data value needs to be stored to the cache/memory (34 in FIG. 2).

In addition, the store queue (50) includes a store queue entry pointer, shown as STQ_PNTR[3:0] (64), that indicates which store queue (50) entry the data cache unit (34) needs to update when the data results of a recently committed store instruction are received from the instruction execution unit (28 in FIG. 3). STQ_PNTR[3:0] (64) is incremented each time the data cache unit (32) stores a new data results entry to the store queue (50). STQ_PNTR[3:0] (64) includes four bits, bits [3:0], to manage 16 entries.

Each entry in the live instruction table (44) may include a single decoded store instruction. In the embodiment shown in FIG. 5, entry 0 (66) includes a first decoded store instruction (labeled decoded_st_inst_{—}1), and entry 1 (68) includes a second decoded store instruction (labeled decoded_st_inst_2). As is further shown in FIG. 5, each entry that includes a store instruction also stores the following attribute fields for the store instruction: RD_VLD (70), RS1_VLD (72), RS2_VLD (74), INST_TYPE (78), ST_TYPE (80), ARF_ID (82), and WRF_ID (84).

In FIG. 5, according to one or more embodiments of the invention, whenever the instruction decode unit (24 in FIG. 2) decodes a store instruction, the instruction decode unit (24 in FIG. 2) attaches the aforementioned attribute fields to the store instruction before forwarding the store instruction to the rename and issue unit (26 in FIG. 2) and the commit unit (30 in FIG. 2). RS1_VLD (72) indicates the validity of the RS1 register (shown in FIG. 3), RS2_VLD (74) indicates the presence and/or validity of the RS2 register (shown in FIG. 3), and RD_VLD (70) indicates the validity of the RD register (shown in FIG. 3).

Further, INST_TYPE (78) indicates that the instruction is a store instruction (rather than a load instruction), ST_TYPE indicates the type of the store instruction (e.g., whether the RD register is an integer register, a floating point register, etc.), ARF_ID indicates the flattened value for the RD register, and WRF_ID[4:0] indicates the working register file ID assigned to the store instruction. INST_TYPE and ST_TYPE are used by the commit unit (30 in FIG. 2) and the rename and issue unit (26 in FIG. 2) to identify the forwarded instruction as a “store” instruction and to identify the type of the store instruction. ARF_ID is used by the commit unit (30 in FIG. 2) to index into the desired architectural register file (42 in FIG. 2) to read data for the store instruction at the time of commit.

Further, the live instruction table (44) maintains a retire pointer, shown as RTR_PNTR[4:0] (76). RTR_PNTR[4:0] (76) is used by the commit unit (30 in FIG. 2) to access the entries in the live instruction table (44). RTR_PNTR[4:0] (76) includes five bits, bits [4:0], to manage a maximum of 32 entries in single strand mode. Although the RTR_PNTR[4:0] (76) may be used to manage 32 entries, the live instruction table cannot store more store instructions than can be processed by the store queue (50) at one time. Accordingly, the live instruction table (44) may store a maximum of 16 store instructions for the active strand.

In dual strand mode, the commit unit (30 in FIG. 2) includes two RTR_PNTRs (one for each strand). As mentioned above, while in dual strand mode, each strand is allocated 16 entries in the live instruction table (44). Accordingly, the commit unit (30 in FIG. 2) ignores a most significant bit of the RTR_PNTR[4:0] (76) and uses a strand identification maintained within the commit unit (30 in FIG. 2) to determine which half of the live instruction table (44) to access. One RTR_PNTR[4:0] is used to access the first 16 entries (entries 0 through 15) of the live instruction table (44), and the other RTR_PNTR[4:0] is used to access the second 16 entries (entries 16 through 31).

Specific instruction formats, registers, and register lengths have been disclosed. Those of ordinary skill in the art will understand that different instruction formats, registers, and/or register lengths may be used without departing from the scope of the present invention. Accordingly, a different number of store instructions may be supported for each strand. Furthermore, a different architectural design may require a different arrangement of the instruction formats, registers, and/or register lengths.

Advantages of the present invention may include one or more of the following. In one or more embodiments, an instruction decode unit included in an out-of-order processor assigns register valid fields to registers included in a store instruction. The register valid fields are forwarded to a rename and issue unit of the out-of-order processor and allow the rename and issue unit to identify the registers. Accordingly, a number of read operations performed by the rename and issue unit for the registers may be reduced based on values of the register valid fields.

In one or more embodiments, because data movement for a store instruction is handled at a time that the store instruction is committed, an out-of-order processor handling the store instruction is able to limit a number of register file read ports required to process the store instruction.

In one or more embodiments, because an out-of-order, multi-stranded processor is able to limit a number of register file read ports required to process a store instruction, a designer is able to limit a number of read ports required for a register file of the out-of-order, multi-stranded processor, thereby decreasing an amount of chip area and power required for the out-of-order, multi-stranded processor.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for limiting a number of register file read ports used to process a store instruction, comprising:
decoding the store instruction, wherein the decoding generates a decoded store instruction;
identifying a store data register and source operand registers included in the decoded store instruction;
appending a set of attribute fields to the decoded store instruction; and
dependent on a value of at least one attribute field of the set of attribute fields, reading source values corresponding to the source operand registers using at least one of the register file read ports at a time that the store instruction is issued, and reading a store data value corresponding to the store data register using one of the register file read ports at a time that the store instruction is committed.

2. The method of claim 1, wherein the set of attribute fields comprises a set of register valid fields, and wherein the source values are read dependent on a value of at least one of the set of register valid fields.

3. The method of claim 1, wherein the set of attribute fields comprises an instruction type field and a store type field, and wherein the store data value is read dependent on at least one selected from a group consisting of the instruction type field and the store type field.

4. The method of claim 1, wherein the reading the store data value comprises:
executing the decoded store instruction, wherein the executing the decoded store instruction generates an address value;
forwarding the address value to a data cache unit; and
committing the decoded store instruction dependent on the forwarding the address value, wherein upon commitment of the decoded store instruction, the store data value is read from an architectural register file and is forwarded to a store queue.

5. The method of claim 4, wherein the decoded store instruction is committed once the decoded store instruction has finished executing without exceptions.

6. The method of claim 4, wherein the address value is generated by an instruction execution unit.

7. The method of claim 6, wherein, upon generation of the address value, the instruction execution unit forwards the address value to the data cache unit, and wherein, upon receipt of the address value, the data cache unit forwards a completion report to a commit unit.

8. The method of claim 7, wherein upon receipt of the completion report, the commit unit commits the decoded store instruction dependent on a value of a retire pointer.

9. The method of claim 7, wherein, upon commitment of the decoded store instruction, the architectural register file sends the store data value to the data cache unit.

10. The method of claim 7, wherein, upon receipt of the address value, the data cache unit generates a physical address value dependent on the address value.

11. The method of claim 10, wherein the commit unit commits the decoded store instruction dependent on whether the physical address value is generated without exceptions.

12. An apparatus for limiting a number of register file read ports used to process a store instruction, comprising:
an instruction decode unit arranged to decode a store instruction into a decoded store instruction and to append a set of attribute fields to the decoded store instruction;
a rename and issue unit arranged to read source operands for the decoded store instruction dependent on values of the set of attribute fields;
an instruction execution unit arranged to execute the decoded store instruction using the source operands, wherein execution of the decoded store instruction generates an address value;
a data cache unit arranged to receive the address value, wherein the data cache unit generates a physical address value dependent on the address value; and
a commit unit arranged to commit the decoded store instruction dependent on the physical address value, wherein, upon commitment of the decoded store instruction, a store data value is stored to a store queue of the data cache unit.

13. The apparatus of claim 12, wherein the decoded store instruction is committed after the physical address value is generated without exceptions.

14. The apparatus of claim 12, wherein the decoded store instruction is decoded into a store data register and source operand registers.

15. The apparatus of claim 14, wherein source operands are read from a register file dependent on the source operand registers, and wherein each source operand is read using one of the register file read ports.

16. The apparatus of claim 14, wherein, upon commitment of the decoded store instruction, the store data value is read from an architectural register file dependent on the store data register using one of the register file read ports.

17. The apparatus of claim 12, wherein the instruction execution unit forwards the store data value to the data cache unit dependent on the commit unit.

18. An apparatus for processing a store instruction, comprising:
means for decoding the store instruction into a set of source operand registers and a store data register;
means for appending a set of attribute fields to the store instruction dependent on the set of source operand registers and the store data register;
means for reading source operands from a register file dependent on values of the set of attribute fields;
means for generating an address value for the store instruction dependent on the source operands and the store instruction;
means for committing the store instruction dependent on the means for generating and the set of attribute fields; and
means for receiving a store data value from the store data register dependent on the means for committing.

19. The apparatus of claim 19, wherein upon generation of the address value, the store instruction is committed dependent on the means for receiving the store data value.

20. The apparatus of claim 20, wherein the store instruction is committed dependent on whether the store instruction finished executing without exceptions.
